(19) United States
(12) Patent Application Publication
(10) Pub. No.: US 2009/0089192 A1
(43) Pub. Date: Apr. 2, 2009

(54) Anticipatory generation and storage of print cost data

(76) Inventor: Andrew Rodney Ferlitsch, Camas, WA (US)

Correspondence Address: Scot Reader, Suite 228, 1320 Pearl Street, Boulder, CO, 80302, US

(21) Appl. No.: 11/906,437

(22) Filed: Oct. 2, 2007

(51) Int. Cl. G06Q 30/00

(52) U.S. Cl. 705/33; 705/30

(57) ABSTRACT

Expedited administrative processing of a pay-for-print job addressing content that was the subject of a previous imaging job is realized through anticipatory generation and storage of print cost data for the content attendant to processing the previous imaging job. Anticipatory generation and storage of print cost data permits highly accurate print cost estimation without incurring a penalty in terms of delayed price quotations or delayed verification of funds for the pay-for-print job.

### BACKGROUND OF THE INVENTION

The present invention relates to expedited printing in pay-for-print environments and, more particularly, to expedited administrative processing of a pay-for-print job addressing content that was the subject of a previous imaging job.

Increasing reliance on mobile computing nodes, such as notebook computers, personal data assistants (PDAs) and cell phones, has spurred demand for pay-for-print services that enable roaming users to initiate chargeable print jobs from their mobile computing nodes. It is desirable to provide these roaming users with on-the-spot price quotations and confirm sufficient funds in their accounts before starting their print jobs. This requires that the pay-for-print service have a mechanism for making accurate and speedy price determinations for print jobs.

Known pay-for-print pricing schemes have reflected a trade-off between accuracy and speed. Some pay-for-print pricing schemes are relatively fast but inaccurate. For example, some schemes charge users a base rate per impression for a black-and-white print job and a premium rate per impression for a color print job. These schemes are able based on minimal analysis of the print job to make fast price determinations. However, the resulting prices often do not closely correlate with the true cost of the print job. The true cost of printing correlates with, among other considerations, the types and amounts of inks used to print the page. Since these schemes fail to take into account the types and amounts of inks used and other relevant cost considerations, they inevitably result in some users being overcharged and others being undercharged. For example, a first customer who wants a color logo printed on the corner of each otherwise black-and-white page pays the rate same rate as a second customer who wants a color photograph to span each page, even though the true cost to print the first customer's print job is much lower than the true cost to print the second customer's print job. Under these schemes, the first customer therefore subsidizes the second customer.

Other pay-for-print pricing schemes are relatively accurate but slow. For example, some schemes estimate ink usage to render prices more reflective of true cost. One of these schemes fully rosterizes each impression of the print job into an engine-ready bitmap and then examines each pixel in the bitmap to determine how much of each type of ink the impression will require when printed. This scheme yields highly accurate price determinations; however, since it requires images to be fully rasterized before conducting the review and inspects every pixel it can be unduly time consuming. Another of these schemes constructs a reduced resolution bitmap of each impression (e.g. thumbnail), examines each pixel of the reduced resolution bitmap and interpolates how much of each type of ink the impression will require when printed. This scheme is less accurate than the former and still requires partial rasterization of images, which can cause a substantial delay in determining prices. Yet another of these schemes analyzes individual color drawing objects of a print job in a pre-roster image process (pre-RIP) to estimate ink usage. While faster than full and partial rasterization schemes, this scheme may be less accurate and may still result in a meaningful delay in determining a price.

### SUMMARY OF THE INVENTION

The present invention, in a basic feature, expedites administrative processing of a pay-for-print job addressing content that was the subject of a previous imaging job through anticipatory generation and storage of print cost data for the content attendant to processing the previous imaging job. Anticipatory generation and storage of print cost data, that is, generation of print cost data before a pay-for-print job is initiated, permits highly accurate print cost estimation without incurring a penalty in terms of delayed price quotations or delayed verification of funds for the pay-for-print job. The print cost data may comprise, for example, an estimate of consumable resources required by the pay-for-print job that has been generated from an analysis of the content.

In one aspect, an imaging node comprises a network interface and a processor communicatively coupled with the network interface, wherein in response to a pay-for-print job received on the network interface addressing content that was a subject of a previous imaging job the processor retrieves from a memory print cost data generated and stored in association with the content attendant to servicing the previous imaging job and applies the print cost data in at least one accounting process for the print job.

In some embodiments, the print cost data are indicative of consumables required to output the pay-for-print job.

In some embodiments, the print cost data comprise one or more of a sheet count, paper type, impression count, connector type, connector count, ink type, ink amount, amortization cost or electro-mechanical operation.

In some embodiments, the print cost data are stored within the content as metadata or commentary.

In some embodiments, the print cost data are generated based at least in part on analysis of pre-RIP content. In some embodiments, the print cost data are generated based at least in part on analysis of individual drawing objects of pre-RIP content, such as text, vector and bitmap objects. In some embodiments, the print cost data are generated based at least in part on analysis of post-RIP content.

In some embodiments, the print cost data are regenerated in response to a change to the content. In some embodiments, a change is detected based on one or more of a change in file size, last write access, checksum or an explicit indication by a user.

In some embodiments, the print cost data are adjusted prior to application in the at least one accounting process to conform to print settings for the print job.

In some embodiments, the pay-for-print job includes the content. In some embodiments, the pay-for-print job includes a reference to the content.

In some embodiments, the imaging job comprises a filing job, a format conversion job, a scan job or a print job.

In some embodiments, the at least one accounting process comprises generation of a price quotation or verification of funds.

In some embodiments, the processor further applies the print cost data to verify consumables on the imaging node sufficient to output the pay-for-print job.

In another aspect, a method for expediting print job processing comprises the steps of receiving an imaging job addressing content, servicing the imaging job, generating print cost data for the content attendant to servicing the imaging job, and storing the print cost data in association with the content; then, receiving a print job addressing the content, retrieving the print cost data and applying the print cost data in at least one administrative process for the print job.

In some embodiments, the at least one administrative process comprises generation of a price quotation, verification of funds or verification of consumables sufficient to output the print job.

In some embodiments, the method further comprises the step of servicing or not the print job depending on an outcome of the at least one administrative process.

In another aspect, a method for expediting print job processing comprises the steps of receiving an imaging job addressing content and servicing the imaging job including generating and storing anticipatory print cost data in association with the content.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in some embodiments of the invention.

FIG. 2 shows an imaging node in some embodiments of the invention.

FIG. 3 shows image job processing elements of an imaging node in some embodiments of the invention.

FIG. 4 shows a method for expediting administrative processing of a pay-for-print job addressing content that was the subject of a previous imaging job in some embodiments of the invention.

### DETAILED DESCRIPTION OF A PREFERRED EMBODIMENT

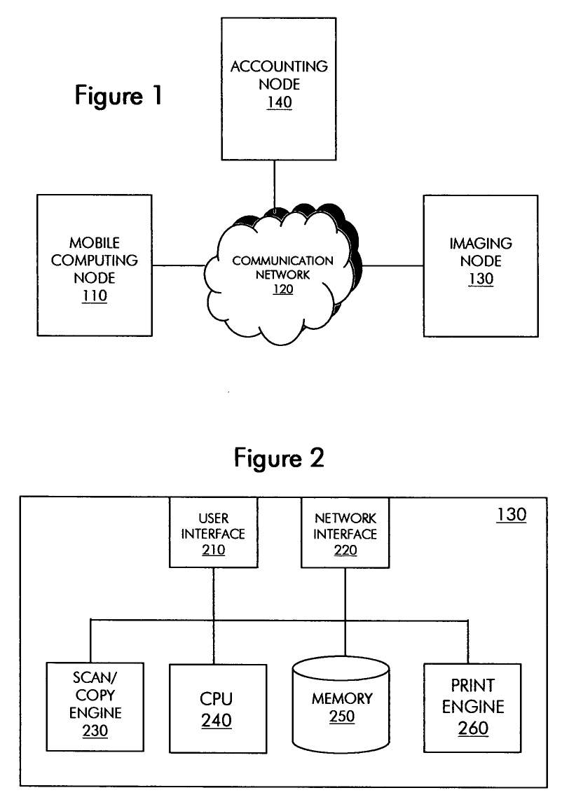

FIG. 1 shows a communication system in which the invention is operative in some embodiments. The system includes a mobile computing node 110, such as a notebook computer, a PDA or cell phone, and an imaging node 130 communicatively coupled with an accounting node 140 over a communication network 120. Naturally, while one mobile computing node 110 and imaging node 130 are shown, a system within the scope of the invention may have a different number of mobile computing nodes and/or imaging nodes.

Mobile computing node 110 is a data communication device that has client software for initiating and transmitting imaging jobs, receiving and displaying price quotations for print jobs and transmitting responses thereto. Imaging jobs are initiated by transmitting them via a wireless network interface of mobile computing node 110, such as a Bluetooth, Infrared Data Association (IrDa), wireless local area network (LAN) (e.g. Wi-Fi), World Interoperability for Microwave Access (WiMAX), or cellular network interface. In some embodiments, the wireless network interface has multiple ports that support different protocols. Imaging jobs may be sent directly to imaging node 130 or may be first preprocessed by an imaging job server node within communication network 120 that, for example, identifies imaging node 130 as a destination for the imaging job and converts the imaging job into an imaging node (IN)-ready format compatible with imaging node 130.

Communication network 120 is a data communication network that may include one or more wired or wireless LANs, wide area networks (WANs), WiMAX networks, cellular networks, ad-hoc and/or other networks each of which may have one or more data communication nodes, such as switches, routers, bridges and/or hubs, operative to communicatively couple mobile computing node 110 and imaging node 130. Communication network 120 in some embodiments traverses the Internet.

Turning to FIG. 2, imaging node 130 is shown in more detail. Imaging node 130 is a multifunction printing (MFP) node that provides multiple types of imaging services, such as printing, scanning, copying, faxing, filing and format conversion. Imaging node 130 has a wired or wireless network interface 220, such as an Ethernet, Universal Serial Bus (USB), WAN, Bluetooth, IrDa, WiFi, WiMAX, or cellular interface that communicatively couple imaging node 130 to communication network 120 and, in some embodiments, to peripheral devices (e.g. USB thumb drive). In some embodiments, network interface 220 has multiple ports that support different protocols. Imaging node 130 also has a user interface 210 for receiving input from walk-up users. Imaging node 130 is capable of receiving via user interface 210 and network interface 220 imaging jobs, such as print jobs, filing jobs, format conversion jobs and scan jobs, in an IN-ready format and processing the imaging jobs. Received imaging jobs may contain the content to be imaged or a reference to the content to be imaged. Internal to imaging node 130, a processor (CPU) 240, a memory 250, user interface 210, network interface 220, a scan/copy engine 230 and a print engine 260 are communicatively coupled. Scan/copy engine 230 includes scanner/copier logic, such as one or more integrated circuits (ICs), and a mechanical section for performing a scanning and copying functions. For example, scan/copy engine 230 may have a line image sensor mounted on a movable carriage for optically scanning a document under the control of a scanner IC and storing the scanned document into memory 250. Print engine 260 includes printer logic, such as one or more printer ICs, and a mechanical section, such as a color ink jet head mounted on a movable carriage, for outputting print data in hard copy format under control of the one or more printer ICs. Memory 250 may consist of one or more random access memories (RAMs) and one or more read only memories (ROM).

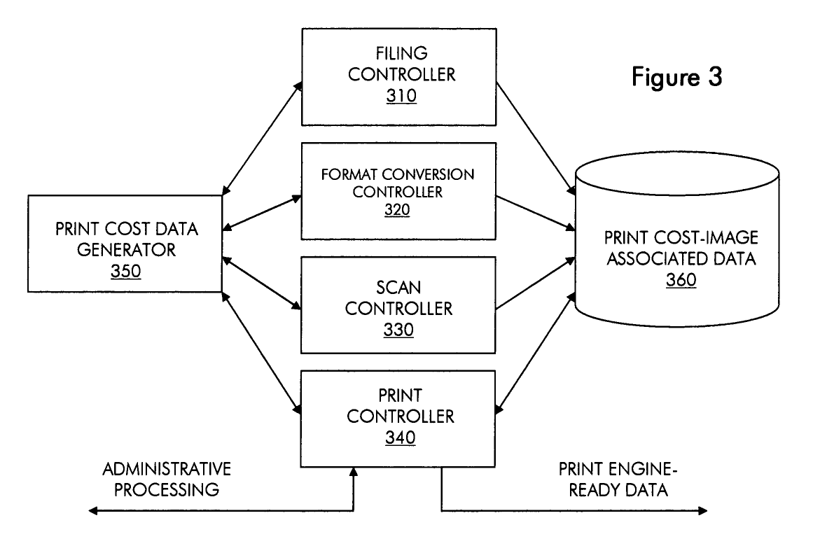

FIG. 3 shows job processing elements of imaging node 130 that are invoked in some embodiments of the invention. The job processing elements include a filing controller 310, a format conversion controller 320, a scan controller 330 and a print controller 340 that are operatively coupled to a print cost data generator 350 and print cost-image associated data (PCIAD) 360. In some embodiments, controllers 310, 320, 330, 340 and generator 350 comprise software executable by processor 240 and PCIAD 360 resides in memory 250, although in other embodiments generator 350 and/or a portion or all of PCIAD 360 may reside outside of imaging node 130. By way of example, PCIAD 360 may be implemented in a system registry, hard drive, non-volatile RAM (NVRAM), database server, storage server, removable storage element or smartcard.

Filing controller 310 is invoked to facilitate servicing of filing jobs received on user interface 210 or network interface 220. A filing job is serviced by converting the filing job content, such as an MS Word document, into print engine-ready data or an intermediate format such as a display list (DL) and storing the converted content in memory 250 or external storage. The filing job content may thereafter be recalled by reference, converted into print engine-ready data (if not already in that form), and submitted to print engine 360 for output in hard copy format. Naturally, conversion to print engine-ready data involves subjecting filing job content to RIP. A filing job may contain the content of the filing job or a reference to the content of the filing job. In the latter case, a filing job may include a Uniform Resource Locator (URL), Uniform Resource Identifier (URI) or a network file path to the filing job content, and filing controller 310 may retrieve the content using the reference. In any event, attendant to servicing a filing job, filing controller 310 invokes print cost data generator 350 to generate anticipatory print cost data for the filing job content and stores the print cost data in PCIAD 360 in association with the content.

Format conversion controller 320 is invoked to facilitate servicing of format conversion jobs received on user interface 210 or network interface 220. A format conversion job is serviced by converting the conversion job content, such as an MS Word document, into an output format and either storing the conversion job content in memory 250 or external storage for later recall or sending the conversion job content to a destination specified in the conversion job. The output format may be, for example, a document format (e.g. MS Word), a page description language (PDL) format, an optical character recognition (OCR) text extraction format, an image format (e.g. TIFF), an eXtensible Markup Language Paper Specification (XPS) document archive format or a web page archive format (e.g. MHT). In some embodiments, format conversion controller 320 invokes a process on an external node, such as a web service, or a guest process, such as a process running under Java Virtual Machine (Java VM), to assist in format conversion. A format conversion job may contain the content of the conversion job or a reference to the content of the conversion job. Attendant to servicing a format conversion job, format conversion controller 320 invokes print cost data generator 350 to generate anticipatory print cost data for the content and stores the print cost data in PCIAD 360 in association with the content.

Scan controller 330 is invoked to facilitate servicing of scan jobs received on user interface 210 or network interface 220. A scan job is serviced by converting the content, such as a hard copy document placed on exposure glass of imaging node 130 for optically scanning by scan/copy engine 230, into scanned data and either storing the scan job content in memory 250 or external storage for later recall or sending the scan job content to a destination specified in the scan job. As an alternative to a hard copy placed on exposure glass, the scan job content may be an inbound fax, digital camera input or electronic whiteboard input, for example. The scanned data format may be, for example, Tagged Image File Format (TIFF), Joint Photographic Experts Group (JPEG), Portable Network Graphics (PNG), Graphics Interchange Format (GIF), Bitmap File Format (BMP), Windows Media Photo (WMP) or Exchangeable Image File Format (EXIF). In some embodiments, scan controller 330 invokes a process on an external node, such as a web service, or a guest process, for post-processing the scanned data such as Bates stamping, encapsulation into a document format or encryption. Attendant to servicing a scan job, scan controller 330 invokes print cost data generator 350 to generate anticipatory print cost data for the content and stores the print cost data in PCIAD 360 in association with the content.

Print controller 340 is invoked to facilitate servicing of print jobs received on user interface 210 or network interface 220. A print job is serviced by converting the print job content, such as an MS Word document, into print engine-ready data and submitting the print engine-ready data to print engine 360 for output in hard copy format. Conversion to print engine-ready data involves subjecting the print job content to RIP. A print job may contain the content of the print job or a reference to the content of the print job. In the latter case, a print job may include a URL, URI or a network file path to the print job content, and print controller 340 may retrieve the content using the reference. Attendant to servicing a print job, print controller 340 invokes print cost data generator 350 to generate anticipatory print cost data for the content and stores the print cost data in PCIAD 360 in association with the content.

Print cost data generator 350 generates anticipatory print cost data by analyzing the content of an imaging job. Print cost data is an estimate of resources that would be consumed or a derivative estimate of the true cost or price to output the content in hard copy format in the event the content is later made the subject of a print job. In generating print cost data, generator 350 analyzes attributes of an imaging job, such as sheet count, paper type, impression count, connector type (e.g. staples, paper clips, etc.), connector count, ink type, ink amount or the amount of electrical power that would be required to output the content in hard copy format. Print cost data may also account for other factors, such as amortization and electro-mechanical operations, such as punching, folding, cutting and stacking. Additionally, print cost data may include a profit margin, which may be built into costing or separately added. To the extent print cost data measures resources consumed, the unit of measurement may be physical (e.g. ink drop count) or relative (e.g. portion of page area covered by ink), or a combination thereof. Moreover, where generator 350 lacks information needed to generate print cost data, for example, where an imaging job lacks information about the number of copies or paper type that might be requested in a later print job, generator 350 applies default settings (e.g. one copy on letter paper). In some embodiments, generator 350 produces multiple instances of print cost data in anticipation of various types of print jobs, for example, a first instance that assumes a full print under settings deduced from the imaging job, a second instance that assumes a full print under default settings, a third instance that assumes printing of individual pages under settings deduced from the imaging job and a fourth instance that assumes printing of individual pages under default settings.

In some embodiments, generator 350 generates print cost data based on analysis of pre-RIP content. Such pre-RIP content may be in a PDL format, such as a Printer Command Language 5c (PCL5c), PCL Level 6 (PCLXL), PostScript or Portable Document Format (PDF); a device independent bitmap format, such as a TIFF, JPEG, PNG, GIF, BMP, WMP or EXIF format; or a document's original format, such as a MS Word format. An ink usage component of print cost data in these embodiments may be determined using various techniques. Generally speaking, a color ink usage estimate is deduced from the area of a logical page covered by ink multiplied by color intensity, accounting for under color removal (UCR). In some embodiments, generator 350 segments a pre-RIP document into logical pages, parses the logical pages into individual drawing objects, estimates color ink usage for individual colors of the individual drawing objects and then aggregates the individual estimates to arrive at an aggregate estimate for the logical pages and/or document as a whole. Generator 350 may in these embodiments apply different rules to determine the coverage area of text objects, vector objects and bitmap objects. For example, each character in a text object may be assigned a character-specific base coverage area that is scaled for font size to estimate the print area of the text object. The coverage area of a vector object may be estimated from the length and width of the path traversed by the vector and the area swept by the vector if it is filled. The coverage area of a bitmap object may be estimated using pixel sampling and interpolation. In some embodiments, drawing objects that are in the cyan, magenta, yellow, black (CMYK) color space are converted into objects in the red, green, blue (RGB) color space before application of the rules, although in other embodiments drawing objects that are in the RGB color space may be converted into objects in the CMYK color space for application of the rules. Moreover, in some embodiments, a separate ink usage estimate is generated for each primary color, for example, individual estimates are generated for red, green and blue. A black ink usage estimate may be similarly determined using the coverage area of individual black-and-white drawing objects.

In other embodiments, generator 350 generates print cost data based on analysis of fully or partially rasterized content. In these embodiments, RIP is first performed to fully or partially rasterize the content and pixel analysis is used to estimate how much of each type of ink the content would require if it were output in hard copy format.

In some embodiments, generator 350 regenerates print cost data in response to a change to stored content. In some embodiments, generator 350 detects a change to stored content based on one or more of a change in file size, last write access or checksum, or an explicit indication by a user.

Generator 350 stores anticipatory print cost data in PCIAD 360 in association with imaging job content to enable expedited administrative processing of subsequent pay-for-print jobs addressing the some content. Print cost data may be stored on a per-logical page, per-impression, per-sheet or per-document basis, for example. In some embodiments, generator 350 embeds print cost data within the content and stores the content in PCIAD 360. For example, print cost data may be inserted in a document having a structured layout in a predetermined or user generated metadata field, in a commentary field or in a proprietary field where insertion would not affect the meaning or rendering of the document; or may be inserted in a document having a free-formatted layout, such as a Microsoft XPS document, at an arbitrary point. In either case, after insertion of the print cost data the document is stored in PCIAD 360. In other embodiments, generator 350 stores print cost data and associated content in physical or logical association within PCIAD 360. For example, print cost data may be stored in a storage object linked to associated stored content through an address pointer. In other embodiments, generator 350 stores print cost data in association with attributes of associated content, such as a name, date, size and/or checksum, within PCIAD 360. In still other embodiments, generator 350 stores print cost data in PCIAD 360 in logical association with associated content that is stored externally. For example, generator 350 may store print cost data in association with a reference to external content, such as a URL, URI or network file path. Moreover, in some embodiments generator 350 performs one or more unit of measurement conversions on print cost data before storing it in PCIAD 360, for example, from units of physical resources consumed to a price.

Print controller 340 references PCIAD 360 to expedite administrative processing of a pay-for-print job received from client node 110 addressing content that was the subject of a previous imaging job for which anticipatory print cost data have been stored in PCIAD 360. More particularly, upon receiving such a print job for processing, print controller 340 checks whether there are print cost data stored in PCIAD 360 in association with the content of the print job. Print controller 340 may use the content itself, attributes of the content (e.g. name, date, size, checksum) or a reference to the content (e.g. URL, URI, network file path) to locate associated print cost data, if any exists, in PCIAD 360. If associated print cost data are not located, administrative processing cannot be expedited. If, however, associated print cost data are located, print controller 340 retrieves the associated print cost data and applies the data in one or more administrative processes. The administrative processes may include accounting processes, such as generation of a price quotation for the print job for presentation to client node 110 (followed by user acceptance or rejection of the price quotation on client node 110) and/or verification with accounting node 140 of sufficient funds to pay for the print job, and/or non-accounting processes such as verification of sufficient consumable resources (e.g. ink, paper) on imaging node 130 to complete the print job. If the outcome of the administrative processes is compatible with completing the print job, print controller 340 converts the print job content into print engine-ready data (e.g. using RIP) and submits the print engine-ready data to print engine 360 for output in hard copy format. If the outcome of the administrative process is incompatible with completing the print job, the print job may be aborted.

In some embodiments, print controller 340 makes one or more adjustments to the print cost data retrieved from PCIAD 360 to enable one or more administrative processes to be successfully performed. For example, print controller 340 may perform one or more unit of measurement conversions, such as converting consumable resources data into price data attendant to generating a price quotation for the print job. Moreover, in some embodiments, print controller 340 scales print cost data to account for differences in assumptions made when the print cost data were generated and assumptions made for the print job. For example, print controller 340 may scale print cost data generated by reference to default print settings (or a default printer) when the print settings (or the printer) selected for the print job differ from the default print settings (or the default printer). Moreover, in some embodiments, in lieu of print controller 340, an upstream print job processing element, such as a printer driver, print processor or print server, may reference PCIAD 360 and undertake the administrative processes.

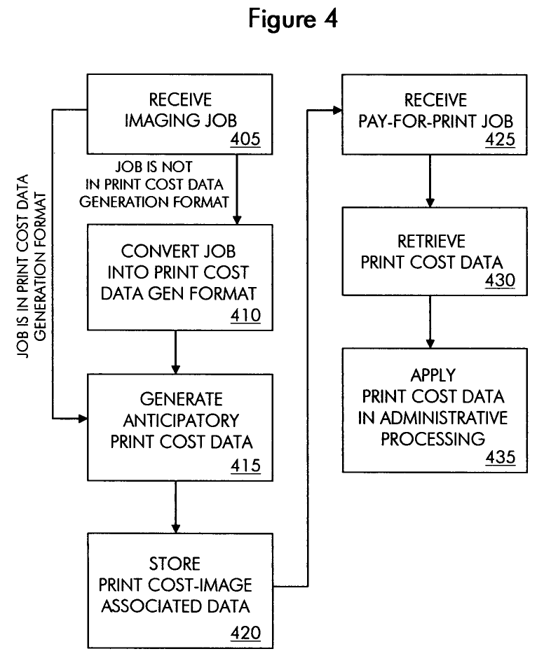

FIG. 4 shows a method for expediting administrative processing of a pay-for-print job addressing content that was the subject of a previous imaging job in some embodiments of the invention. An imaging job is received (405) and a determination is made whether the imaging job is in a format suitable to generate print cost data. If not, the imaging job is converted into a format suitable for generating print cost data (410). In either event, attendant to servicing the imaging job, anticipatory print cost data are generated for the content of the imaging job (415) and stored in PCIAD in association with the content (420). It will be appreciated that the primary imaging task (i.e. filing, format conversion, scanning, printing) may be performed before, during or after generation and storing of the anticipatory print cost data. A pay-for-print job is then received addressing the same content (425) and the anticipatory print cost data associated with the content are retrieved (430) and applied in one or more administrative processes (435) to expedite processing of the pay-for-print job.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

1. An imaging node, comprising:
a network interface; and
a processor communicatively coupled with the network interface, wherein in response to a pay-for-print job received on the network interface respecting content that was a subject of a previous imaging job the processor retrieves from a memory print cost data generated and stored in association with the content attendant to servicing the previous imaging job and applies the print cost data in at least one accounting process for the pay-for-print job.

2. The imaging node of claim 1, wherein the print cost data are indicative of consumables required to output the pay-for-print job.

3. The imaging node of claim 1, wherein the print cost data comprise one or more of a sheet count, paper type, impression count, connector type, connector count, ink type, ink amount, amortization cost, power consumption, or electro-mechanical operation.

4. The imaging node of claim 1, wherein the print cost data are stored within the content as metadata.

5. The imaging node of claim 1, wherein the print cost data are generated based at least in part on analysis of pre-raster image process (RIP) content.

6. The imaging node of claim 5, wherein the print cost data are generated based at least in part on analysis of individual drawing objects of pre-RIP content.

7. The imaging node of claim 1, wherein the print cost data are generated based at least in part on analysis of post-RIP content.

8. The imaging node of claim 1, wherein the print cost data are regenerated in response to a change to the content.

9. The imaging node of claim 1, wherein the print cost data are adjusted prior to application in the at least one accounting process to conform to selected settings for the pay-for-print job.

10. The imaging node of claim 1, wherein the pay-for-print job includes the content.

11. The imaging node of claim 1, the pay-for-print job includes a reference to the content.

12. The imaging node of claim 1, wherein the imaging job comprises a filing job, format conversion job or scan job.

13. The imaging node of claim 1, wherein the imaging job comprises a print job.

14. The imaging node of claim 1, wherein the at least one accounting process comprises generation of a price quotation.

15. The imaging node of claim 1, wherein the at least one accounting process comprises verification of funds.

16. The imaging node of claim 1, wherein the processor further applies the print cost data to verify consumables on the imaging node sufficient to output the print job.

17. A method for expediting pay-for-print job processing, comprising the steps of:
receiving an imaging job addressing content;
servicing the imaging job including generating print cost data for the content and storing the print cost data in association with the content; then,
receiving a pay-for-print job addressing the content;
retrieving the print cost data; and
applying the print cost data in at least one administrative process for the pay-for-print job.

18. The method of claim 17, wherein the at least one administrative process comprises generation of a price quotation, verification of funds or verification of consumables sufficient to output the pay-for-print job.

19. The method of claim 17, wherein the method further comprises the step of servicing or not the pay-for-print job depending on an outcome of the at least one administrative process.

20. (canceled)

21. A method for expediting pay-for-print job processing, comprising the steps of:
generating print cost data for content and storing the print cost data in association with the content while no pay-for-print job addressing the content is pending; then,
receiving a pay-for-print job addressing the content;
retrieving the print cost data; and
applying the print cost data in at least one administrative process for the pay-for-print job.
